(19) United States
(12) Patent Application Publication
(10) Pub. No.: US 2016/0314795 A1
(43) Pub. Date: Oct. 27, 2016

(54) METHOD AND APPARATUS FOR WATERMARKING AN AUDIO SIGNAL

(71) Applicant: THOMSON LICENSING, Issy-les-Moulineaux (FR)

(72) Inventors: Peter Georg BAUM, Hannover (DE); Xiaoming CHEN, Hannover (DE); Michael ARNOLD, Isernhagen (DE); Ulrich GRIES, Hannover (DE)

(21) Appl. No.: 15/102,893

(22) PCT Filed: Dec. 1, 2014
(86) PCT No.: PCT/EP2014/076108

§ 371 Date: Jun. 9, 2016

(30) Foreign Application Priority Data
Dec. 9, 2013 (EP) 13306687.8

(51) Int. Cl. G10L 19/018; G10L 19/24; G10L 21/0232

(52) U.S. Cl. CPC G10L 19/018; G10L 21/0232; G10L 19/24

(57) ABSTRACT

Improvement of water-mark detection in watermarked microphone audio signals picked up in the presence of surrounding noise is achieved by using at encoder side not only the originally received signal for the calculation of the masking threshold and the watermarking strength, but by also taking into account the level of the surrounding noise. This enables an adaptation of the watermarking strength to the current sound pressure level SPL of the surrounding noise. If the SPL of the surrounding noise is increased, the watermarking strength will be increased accordingly. The resulting advantage is a significantly improved audio watermark detection in the presence of surrounding noise.

### TECHNICAL FIELD

The invention relates to a method and to an apparatus for watermarking an audio signal taking also into account surrounding noise.

### BACKGROUND

Audio watermarking is the process of embedding in an in-audible way information into an audio signal. The embedding is performed by changing the audio signal for example by adding pseudo-random noise or echoes. To make the embedding in-audible, the strength of the embedding is controlled by a psycho-acoustical analysis of the signal. At receiver side, the watermark can be detected by performing correlation with a pseudo-random noise bit sequence.

### SUMMARY OF INVENTION

The main challenge of current audio watermarking systems is the robustness against microphone pickup. Especially if there is surrounding noise, it is very difficult to detect the watermark in a watermarked signal that is played back via loudspeaker.

A problem to be solved by the invention is to provide improved watermark detection capabilities for microphone audio signals picked-up in the presence of surrounding noise. This problem is solved by the method disclosed in claim 1. An apparatus that utilises this method is disclosed in claim 7.

The inventive improvement of watermark detection in watermarked microphone audio signals picked up in the presence of surrounding noise is achieved by using at encoder side not only the originally received signal for the calculation of the masking threshold and the watermarking strength, but by also taking into account the level of the surrounding noise. This enables an adaptation of the watermarking strength to the current sound pressure level (SPL) of the surrounding noise. If the SPL of the surrounding noise is increased, the watermarking strength will be increased accordingly. The resulting advantage is a significantly improved audio watermark detection in the presence of surrounding noise.

In principle, the inventive method is suited for watermarking an audio signal, including the steps:

receiving an audio signal and receiving surrounding noise signal or data about a surrounding noise signal;

calculating a masking threshold for said audio signal, wherein said masking threshold is to be used for embedding watermark payload data and related error correction data, and wherein for calculating said masking threshold the characteristics of said audio signal as well as the characteristics of said surrounding noise are taken into account;

embedding said watermark payload data and said error correction data into said audio signal and providing the correspondingly watermarked audio signal.

In principle the inventive apparatus is suited for watermarking an audio signal, said apparatus including:

means being adapted for receiving an audio signal and for receiving surrounding noise signal or data about a surrounding noise signal;

means being adapted for calculating a masking threshold for said audio signal, wherein said masking threshold is to be used for embedding watermark payload data and related error correction data, and wherein for calculating said masking threshold the characteristics of said audio signal as well as the characteristics of said surrounding noise are taken into account;

means being adapted for embedding said watermark payload data and said error correction data into said audio signal and for providing the correspondingly watermarked audio signal.

Advantageous additional embodiments of the invention are disclosed in the respective dependent claims.

### BRIEF DESCRIPTION OF DRAWINGS

Exemplary embodiments of the invention are described with reference to the accompanying drawings, which show in:

FIG. 1 Different masking regions;

FIG. 2 Block diagram of the inventive processing;

FIG. 3 Example application.

### DESCRIPTION OF EMBODIMENTS

Even if not explicitly described, the following embodiments may be employed in any combination or sub-combination.

For the inventive processing the following application is assumed:
The watermark information embedding into an original audio signal is carried out in real-time in a device connected to a loudspeaker, or a device generating watermarked audio signals intended for a presentation by a loudspeaker or loudspeakers;
The corresponding watermarked audio signal is played back by that loudspeaker or loudspeakers;
A separate device picks up the sound and detects the embedded watermark information, which watermark information is used for example for second-screen applications synchronisation.

Such application happens for example if 2nd screen watermarking embedding is performed in a set-top box or a TV receiver (or any other device emitting sound). The original audio signal to be watermarked is the non-watermarked audio signal received. A listener watching the TV program has a device including a screen (e.g. a tablet computer or a smart phone), which device receives the watermarked acoustic waves from the loudspeaker of the TV receiver. In a store, a shopper has a mobile device which receives watermarked acoustic waves from one or more loudspeakers arranged nearby his current position within the store, and the watermarked acoustic waves are used for video merchandising or advertising products presented at his current position within that store (like IZ•GN in the USA).

Usually the audio signal is analysed at watermark encoder side and the strength of the embedding is selected based on such analysis, such that the watermark is not audible. This works quite well if there is no surrounding noise. However, if there is surrounding noise (at a listener position), the ratio between watermark amplitude and disturbing noise amplitude (i.e. signal to noise ratio SNR) gets smaller, which means that the correct-detection rate of the watermark detector will decrease.

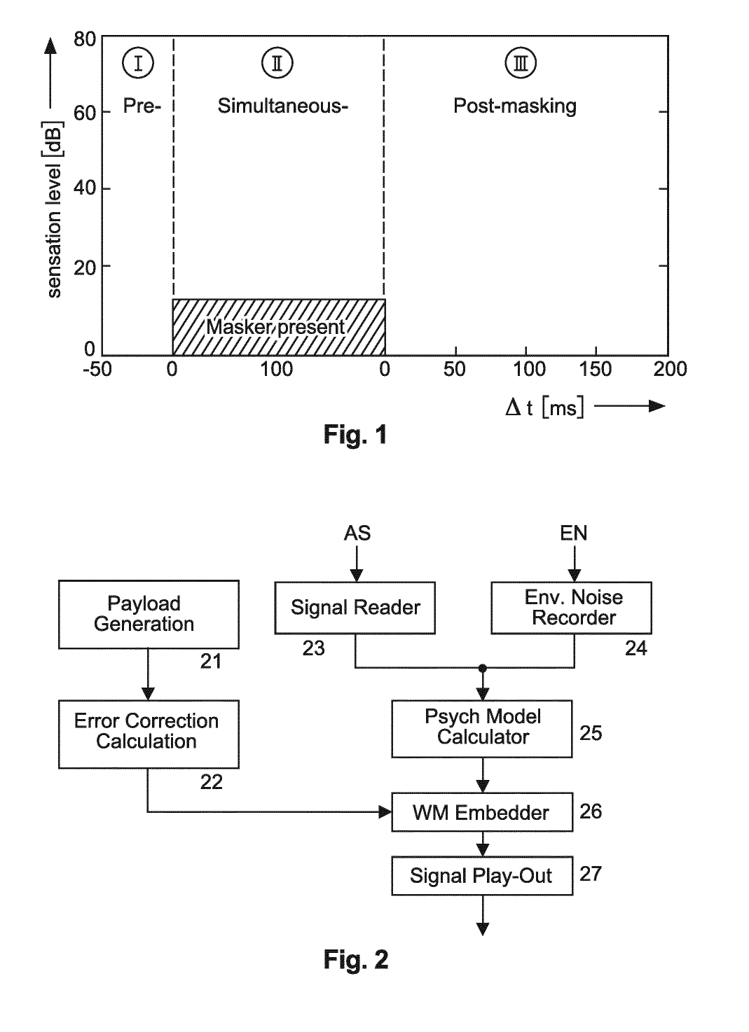

Usually, the strength of watermark information embedding is controlled by a masking threshold which quantitatively measures the effect of masking. The maskee depicted in FIG. 1 is the tone which masks out other sound, whereas the test sound is the sound which will be masked (i.e. the watermark signal).

However, in general, two different situations can be distinguished regarding the time relation Δt between the masker and the test sound:
Simultaneous masking as depicted in region II of FIG. 1;
Non-simultaneous masking as depicted in regions I and III of FIG. 1: pre-masking in region I and post-masking in region III.

The masking threshold of the original signal is derived from the simultaneous masking region, since the original audio signal is available at the time of embedding, whereby the analysis is carried out in blocks having a time resolution of about 10-20 ms.

According to the invention, the embedding device evaluates the signal of a microphone which picks up the surrounding noise. For the calculation of the embedding strength not only (the level of) the audio content itself is used, but also (the level of) the surrounding noise. Since the surrounding noise has the effect of an additional psycho-acoustical masker, the watermark strength can be increased without becoming audible.

Since the surrounding noise has to be recorded or stored before the analysis of the corresponding noise masking threshold can be derived, it naturally fits into the non-simultaneous post-masking region, i.e. into region III in FIG. 1. Although there will be a decay of the post-masking threshold in comparison to the masking threshold within the simultaneous masking region, that decay is limited for Δt<50 ms.

If there is no surrounding noise, the embedding strength is the same as in the prior art. If there is surrounding noise, the embedding strength will be increased, which means that the watermark robustness will be higher and the detection rate of the audio watermark detector will be better. I.e., the more surrounding noise the higher the embedding strength, which mitigates the above-mentioned surrounding noise prior art problems.

In FIG. 2 a step or stage 21 generate payload data for a watermarking to be carried out, followed by a corresponding error correction data calculation step or stage 22. A signal reader step or stage 23, which can be a device including a microphone, receives an audio signal AS to be watermarked. Further, an environment or surrounding or ambient noise recorder 24 receives the related environment noise EN. Recorder 24 can be included in the device with the microphone. A psycho-acoustical model calculating step or stage 25 calculates for each section of the audio signal AS a combined masking threshold for watermark signal insertion, thereby taking into account the current audio signal magnitude level as well as the corresponding surrounding noise level. Following masking threshold calculation, in a watermark embedding step or stage 26 the payload data including the error correction data are embedded into the audio signal with a strength according to the combined masking threshold. The correspondingly watermarked audio signal is thereafter played out by a device 27, e.g. an amplifier and a loudspeaker.

Normally the masker is frequency dependent, and the frequency distribution of the original audio microphone signal and of the ambient noise microphone signal is taken into account.

There are several ways for taking the ambient noise into account. If the microphone is located at the same position as the listener (for example, a microphone included in a TV remote control or a tablet computer or a smart phone), the psycho-acoustical model can be calculated based on the—possibly weighted—sum of the original signal and the ambient noise signal. The current characteristics of the ambient noise are transferred to the watermark embedder. The mobile device (e.g. the remote control) can send e.g. via infrared signal or via electromagnetic waves like Bluetooth or WLAN or via ultrasound (i.e. any kind of transmission except acoustic waves in the human audible range) data about the current ambient noise characteristics to the TV receiver or to the set top box, i.e. to the device that emits the watermarked sound signal or acoustic waves. The remote control includes an IR command transmitter and a microphone, which microphone receives an audio signal (i.e. the surrounding noise), and the microphone-received audio signal or data about that audio signal can be transmitted via the IR command transmitter.

Another solution is to calculate for both signals one psycho-acoustical model and to calculate the final masking threshold by adding—possibly weighted—both masking thresholds.

If it is important to keep low the complexity of the calculation, it is also possible to calculate the full psycho-acoustical model only for the original audio microphone signal and to calculate a scalar value for the ambient noise microphone signal, for example the—possibly frequency weighted (for example A-weighted)—sound pressure level. The final masking threshold is then the masking threshold of the original audio microphone signal shifted by the scalar value derived from the ambient noise microphone signal.

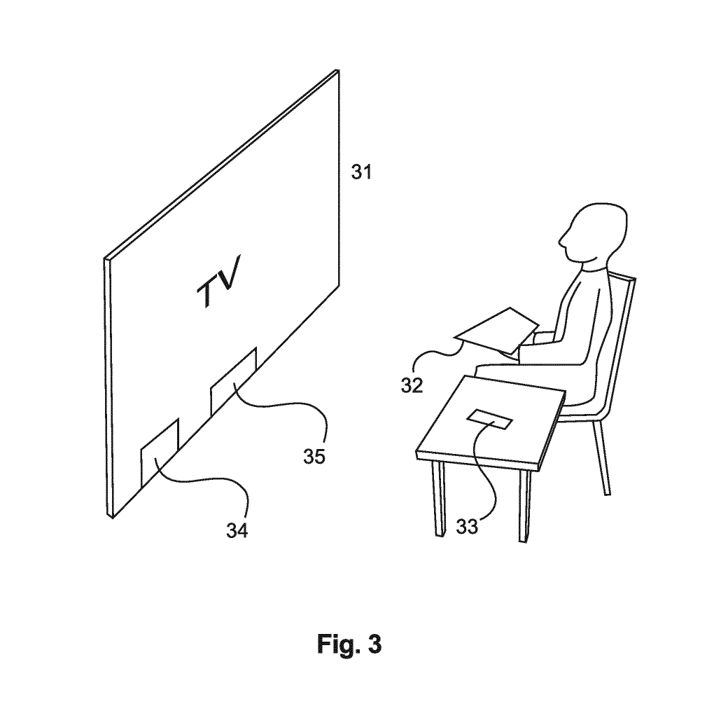

FIG. 3 shows a person watching a TV 31 and a tablet display or device 32. Nearby the person a remote control 33 is located which includes a microphone receiving surrounding noise and which sends a corresponding surrounding noise data signal to a receiving unit 34 of the TV 31. The received signal is evaluated in a block 35 which may comprise the processing blocks shown in FIG. 2. The TV 31 produces correspondingly watermarked sound that is received in device 32 and can be used for 2nd screen applications.

The described processing (in device 31) can be carried out by a single processor or electronic circuit, or by several processors or electronic circuits operating in parallel and/or operating on different parts of the complete processing. The instructions for operating the processor or the processors according to the described processing can be stored in one or more memories. The at least one processor is configured to carry out these instructions.

1. A method for watermarking an audio signal, including:
receiving an audio signal and receiving a surrounding noise signal;
calculating a masking threshold for said audio signal, wherein said masking threshold is used for embedding watermark payload data, and wherein for calculating said masking threshold the characteristics of said audio signal as well as the characteristics of said surrounding noise are taken into account;
embedding said watermark payload data into said audio signal and providing the correspondingly watermarked audio signal.

2. The method according to claim 1, further including:
using said masking threshold also for embedding error correction data for said watermark payload data into said audio signal.

3. The method according to claim 1, further including:
recording or storing said surrounding noise signal, corresponding to a postmasking region, before said masking threshold calculation.

4. The method according to claim 1, further including:
using said watermark payload data for second-screen applications synchronisation.

5. The method according to claim 1, wherein the masking threshold is frequency dependent, and the frequency distribution of said audio signal and of said surrounding noise signal are taken into account for determining the watermarking strength to be applied.

6. The method according to claim 1, wherein a microphone is included in a mobile device—e.g. a remote control—and said mobile device sends—e.g. via infrared signal—surrounding noise signal data, which can represent data about the current ambient noise characteristics, to a device which performs said audio signal watermarking, e.g. to a TV receiver or to a set top box.

7. An apparatus for watermarking an audio signal, said apparatus including:
means adapted for receiving an audio signal and for receiving a surrounding noise signal;
means adapted for calculating a masking threshold for said audio signal, wherein said masking threshold is used for embedding watermark payload data, and wherein for calculating said masking threshold characteristics of said audio signal as well as characteristics of said surrounding noise are taken into account;
means adapted for embedding said watermark payload data into said audio signal and for providing the correspondingly watermarked audio signal.

8. The apparatus according to claim 7, wherein said masking threshold is also used in said embedding means for embedding error correction data for said watermark payload data into said audio signal.

9. The apparatus according to claim 7, wherein said surrounding noise signal is recorded or stored before said masking threshold calculation and corresponds to a post-masking region.

10. The apparatus according to claim 7, wherein said watermark payload data is used for second-screen applications synchronisation.

11. The apparatus according to claim 7, wherein the masking threshold is frequency dependent, and the frequency distribution of said audio signal and of said surrounding noise signal are taken into account for determining the watermarking strength to be applied.

12. The apparatus according to claim 7, which receives said data about surrounding noise from non-acoustic waves emitted from a mobile device with a microphone, which surrounding noise signal data can represent data about the current ambient noise characteristics.

13. An apparatus for watermarking an audio signal, comprising:
a memory that stores data which control operation of a processor;
said processor, which executes a procedure comprising:
receiving an audio signal and receiving a surrounding noise signal;
calculating a masking threshold for said audio signal, wherein said masking threshold is used for embedding watermark payload data and related error correction data, and wherein for calculating said masking threshold the characteristics of said audio signal as well as the characteristics of said surrounding noise are taken into account;
embedding said watermark payload data and said error correction data into said audio signal and providing the correspondingly watermarked audio signal.
